(19) United States
(12) Patent Application Publication
(10) Pub. No.: US 2002/0164239 A1
(43) Pub. Date: Nov. 7, 2002

(54) Tiltable cargo box assembly with extension ramp

(76) Inventor: Gregory Robert Angermeier, Waxhaw, NC (US)

Correspondence Address: T. Peige Wise, Adams, Schwartz & Evans, P.A., 2180 Two First Union Center, Charlotte, NC, 28282, US

(21) Appl. No.: 09/850,276

(22) Filed: May 7, 2001

(51) Int. Cl. B60P 3/06

(52) U.S. Cl. 414/480; 414/537; 14/71.1

(57) ABSTRACT

A tiltable cargo box assembly for mounting on a vehicle, supporting a load, and transporting the load into and out/of the vehicle and includes a cargo box adapted for receiving the load therein. An attachment assembly is connected to a rear end of the box for pivotally mounting the box to the vehicle adjacent a rear axle thereof. A ramp assembly for carrying the load is slidably mounted to a floor of the box for reciprocating movement between extended and retracted positions relative to the floor. An actuator is mounted toward a forward end of the box intermediate the attachment assembly and a forward axle of the vehicle for being operatively connected to a power source of the vehicle and cooperates with the attachment assembly for moving the forward end between a lowered position and an elevated position wherein the floor is tilted at an angle relative to the lowered position for permitting the load to be transported into and out of the box.

### TECHNICAL FIELD AND BACKGROUND OF THE INVENTION

This invention relates to a tiltable cargo box assembly for use on a vehicle, such as a pick-up truck. The cargo box assembly includes an extendable ramp, and is used for loading and unloading heavy objects onto and off of the vehicle. Such objects include, but are not limited to, lawn mowers, garden tractors, small motorcycles, other similarly sized all-terrain vehicles and any other large objects which could not otherwise be easily lifted into or out of the vehicle. The unique structure of the cargo box assembly of the present invention permits such objects to be loaded onto and unloaded from the truck safely and efficiently.

Although prior art cargo loading and unloading systems exist for use on standard pick-up trucks and other vehicles, such systems are inadequate due to limitations in structure and function. For example, while some prior art systems include cargo boxes or platforms which may be tilted for permitting a load to be pushed or otherwise moved into the box or onto the platform, such systems lack extendable ramps, relying instead upon manual movement of the box or platform between elevated and lowered positions, which increases the risk of injury to the person or persons operating the system and moving the load. Those prior art system providing extendable ramps do so at the expense of sacrificing the external appearance of the vehicle. Such ramps cannot be installed on a conventional pick-up truck without permanently removing the tailgate and bumper, which irreversibly alters the structure and appearance of the back of the truck.

The present invention overcomes the disadvantages inherent to prior art extension ramps and tiltable cargo boxes by providing a cargo box assembly which includes a tiltable cargo box and an extendable ramp. The cargo box assembly is installed on a conventional pick-up truck without changing the outward appearance of the truck. Unlike prior art cargo box systems, the cargo box assembly of the present invention takes advantage of the electrical system of the truck or other vehicle upon which it is mounted by using the power provided by the electrical system to operate a hydraulic lift for moving the cargo box between elevated and lowered positions, and a winch assembly for moving the ramp between extended and retracted positions. The combined use of the electrically-powered hydraulic lift and winch assembly eliminates the need to rely upon manual labor to tilt the cargo box and extend the ramp and thus enhances the safety of persons using the cargo box assembly.

In contrast to a typical prior art cargo system which cannot be installed on a conventional pick-up truck without altering the original appearance of the truck, the cargo box assembly of the present invention preserves the structural integrity of the truck upon which it is installed. This is achieved by incorporating the factory-installed cargo box included with the truck at the time of purchase into the invention itself. This novel use of the original cargo box of the truck results in a cargo box assembly that is difficult to detect when the assembly is not in use, yet emerges at the option and under the direction of the operator to provide a powerful tool for safely transporting loads into and out of the truck.

### SUMMARY OF THE INVENTION

It is therefore an object of the invention to provide a cargo box assembly which is capable of being tilted between elevated and lowered positions and includes a ramp which can be moved between extended and retracted positions.

It is another object of the invention to provide a cargo box assembly that can be installed on a conventional pick-up truck without altering the external appearance of the body of the truck.

It is another object of the invention to provide a cargo box assembly which is formed from components that are inexpensive and readily available the user in multiple forms.

It is another object of the invention to provide a cargo box assembly that utilizes the electrical system of the truck or other vehicle upon which it is installed as its primary source of power, thereby eliminating the need to move the ramp or cargo box manually, which in turn increases the safety of persons operating the cargo box assembly.

It is another object of the invention to provide a cargo box assembly having a structure and components strong enough to support a heavy load.

These and other objects of the invention are achieved as described below by providing a tiltable cargo box assembly for mounting on a vehicle, supporting a load, and transporting the load into and out of the vehicle. The cargo box assembly includes a cargo box adapted for receiving the load therein. An attachment assembly is connected to a rear end of the cargo box for pivotally mounting the cargo box to the vehicle adjacent a rear axle thereof. A ramp assembly for carrying the load is slidably mounted to a floor of the cargo box for reciprocating movement between extended and retracted positions relative to the floor of the cargo box. An actuator is mounted toward a forward end of the cargo box intermediate the attachment assembly and a forward axle of the vehicle for being operatively connected to a power source of the vehicle. The actuator cooperates with the attachment assembly for moving the forward end between a lowered position and an elevated position, wherein the floor of the cargo box is tilted at an angle relative to the lowered position for permitting the load to be transported into and out of the cargo box.

According to one preferred embodiment of the invention, the ramp assembly includes an extendable ramp having first and second spaced-apart opposing major side edges and a carriage assembly supporting the ramp for slidably moving the ramp relative to the floor of the cargo box, thereby moving the ramp assembly between the extended and retracted positions.

According to another preferred embodiment of the invention, the carriage assembly includes first and second spaced-apart base rails carried on the floor. A plurality of rollers are rotatably mounted in spaced-apart relation along the length of each of the first and second base rails. First and second guide rails are mounted to the ramp adjacent the first and second major side edges of the ramp and extend along the length thereof for engaging and cooperating with the rollers for moving the ramp relative to and along the length of the base rails.

According to yet another preferred embodiment of the invention, the ramp assembly further includes a base plate mounted to the floor of the cargo box and positioned beneath the ramp for supporting sliding movement of the ramp relative to the floor.

According to yet another preferred embodiment of the invention, the ramp assembly further includes first and second end rollers rotatably mounted on the first and second guide rails, respectively, for preventing the ramp from separating from the base plate when the ramp assembly is in the extended position.

According to yet another preferred embodiment of the invention, the cargo box assembly further includes a winch assembly connected to the cargo box, operatively connected to the power source of the vehicle, and releasably connected to the ramp for moving the ramp assembly between the extended and retracted positions.

According to yet another preferred embodiment of the invention, the winch assembly is connected to the floor of the cargo box adjacent the forward end thereof.

According to yet another preferred embodiment of the invention, the winch assembly includes a cable having a first end releasably connected to the ramp and winding means connected to a second end of said cable for winding and unwinding the cable, thereby moving the ramp assembly between the retracted and extended positions.

According to yet another preferred embodiment of the invention, the winch assembly further includes an eye connected to the ramp for receiving the first end of the cable therethrough for permitting the first end of the cable to be releasably connected to the load and for guiding the cable as it is wound and unwound by the winding means, thereby transporting the load into and out of the cargo box, respectively, when the forward end of the cargo box is in said elevated position. A hook is attached to the first end of the cable for releasably connecting the cable to the load, and a collar encircles and engages the cable between the eye and the hook. The collar cooperates with the eye for moving the cable through a first range of motion wherein the collar resides between the eye and the load, for permitting the hook to be releasably connected to the load for properly positioning the load on the ramp as the winding means rewinds the cable, and through a second range of motion wherein the collar engages the eye, thereby translating movement of the cable into movement of the ramp for moving the ramp assembly between the extended and retracted positions.

The winding means is preferably a winch.

An embodiment of a method of supporting a load and transporting the load into and out of a vehicle includes the step of providing a tiltable cargo box assembly. The cargo box assembly includes a cargo box adapted for receiving the load therein, an attachment assembly connected to a rear end of the cargo box for pivotally mounting the cargo box on the vehicle adjacent a rear axle thereof, and a ramp assembly for carrying the load and slidably mounted to a floor of the cargo box for reciprocating movement between extended and retracted positions relative to the floor of the cargo box. An actuator is mounted towards a forward end of the cargo box intermediate the attachment assembly and a forward axle of the vehicle for being operatively connected to a power source of the vehicle and cooperates with the attachment assembly for moving the forward end between a lowered position and an elevated position, wherein the floor of the cargo box is tilted at an angle relative to the lowered position for permitting the load to be transported into and out of the cargo box. The method further includes the steps of mounting the cargo box assembly on the vehicle adjacent a rear axle thereof, moving the forward end of the cargo box to the elevated position, moving the ramp assembly to the extended position, positioning the load on the ramp assembly, moving the ramp assembly to the retracted position; and moving the forward end of the cargo box to the lowered position, thereby positioning the load in the vehicle.

### BRIEF DESCRIPTION OF THE DRAWINGS

Some of the objects of the invention have been set forth above. Other objects and advantages of the invention will appear as the description proceeds when taken in conjunction with the following drawings, in which:

FIG. 1 is a cut-away, environmental side elevation of a cargo box assembly according to the present invention;

FIG. 2 is a rear elevation of the cargo box assembly shown in FIG. 1 with the tailgate removed;

FIG. 3 is an environmental side view of the cargo box assembly shown in FIG. 1 with the ramp assembly in an extended position;

FIG. 4 is a top plan view of the cargo box assembly removed shown in FIG. 1 removed from the truck and showing the ramp assembly in the extended position;

FIG. 5 is a top plan view according to FIG. 4 and showing the ramp assembly in a retracted position;

FIG. 6 is a cross-sectional view taken along Line 6-6 of FIG. 5; and

FIGS. 7 through 11 are each environmental side elevations showing a load being transported in and out of a truck using the cargo box assembly of the present invention.

### DESCRIPTION OF THE PREFERRED EMBODIMENT AND BEST MODE

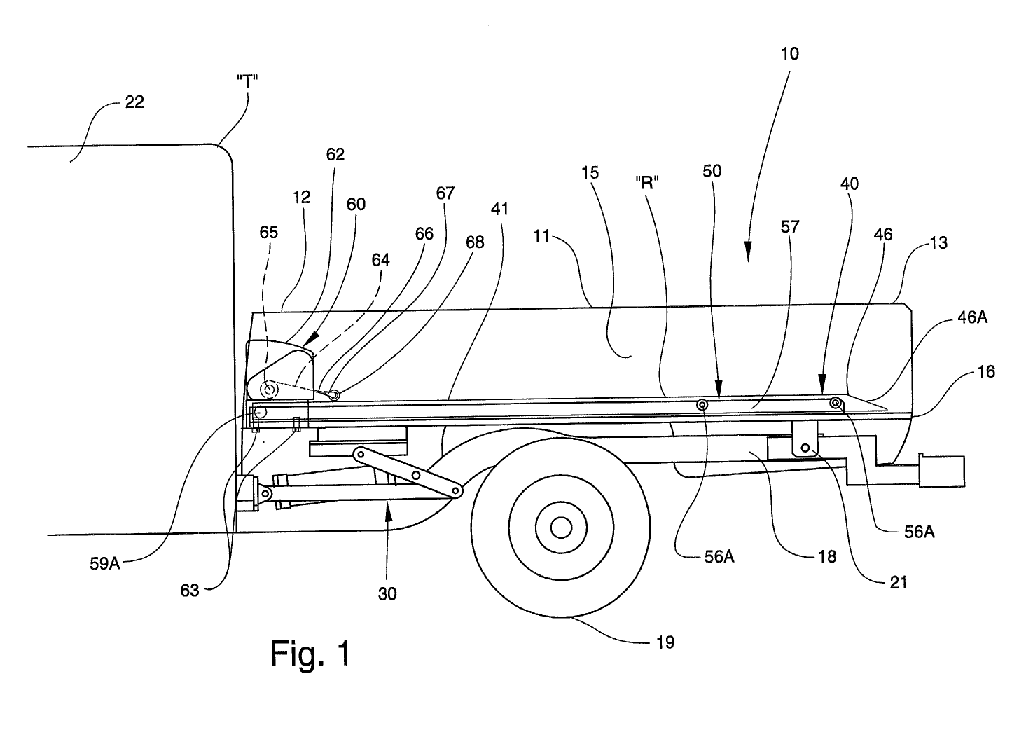

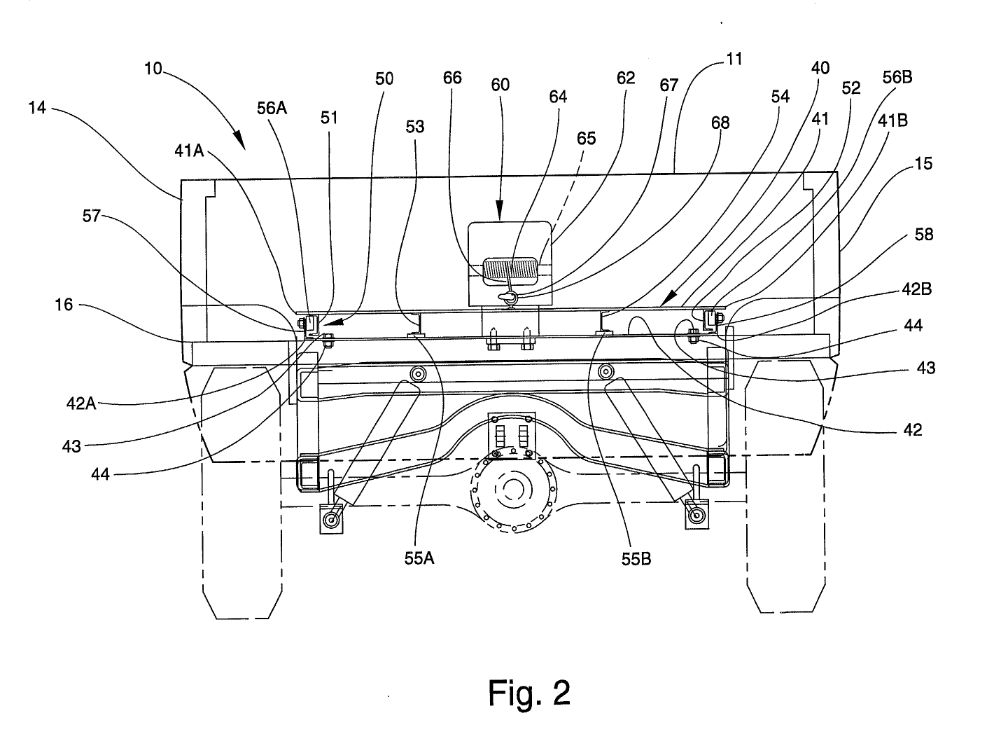

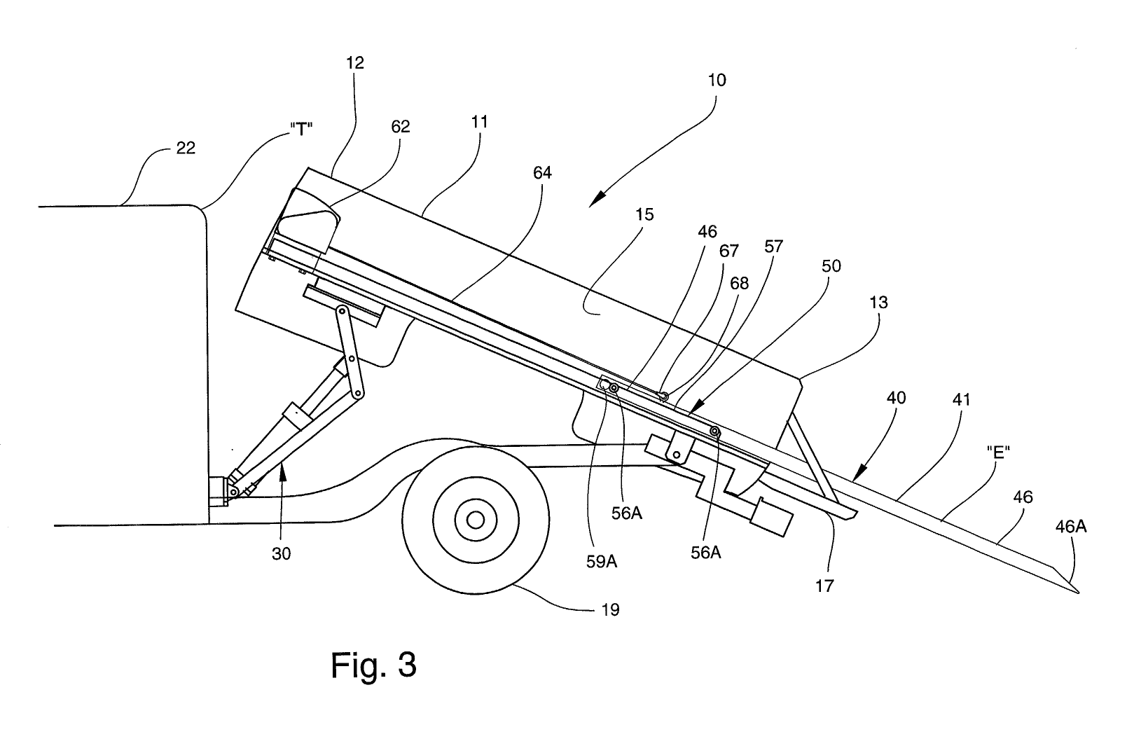

Referring now specifically to the drawings, a tiltable cargo box assembly according to the present invention is illustrated in FIG. 1 and shown generally at reference numeral 10. While the cargo box assembly 10 may be mounted and used on any vehicle having a cargo box or flat bed, the cargo box assembly 10 is preferably mounted on a standard pick-up truck “T”. The cargo box assembly 10 includes a cargo box 11 which has forward and rear ends 12 and 13, respectively. As is shown in FIG. 2, the cargo box 11 also includes sidewalls 14 and 15 which are connected to opposing side edges of a floor 16 of the cargo box 11. As is shown in FIG. 3, the cargo box also includes a tailgate 17.

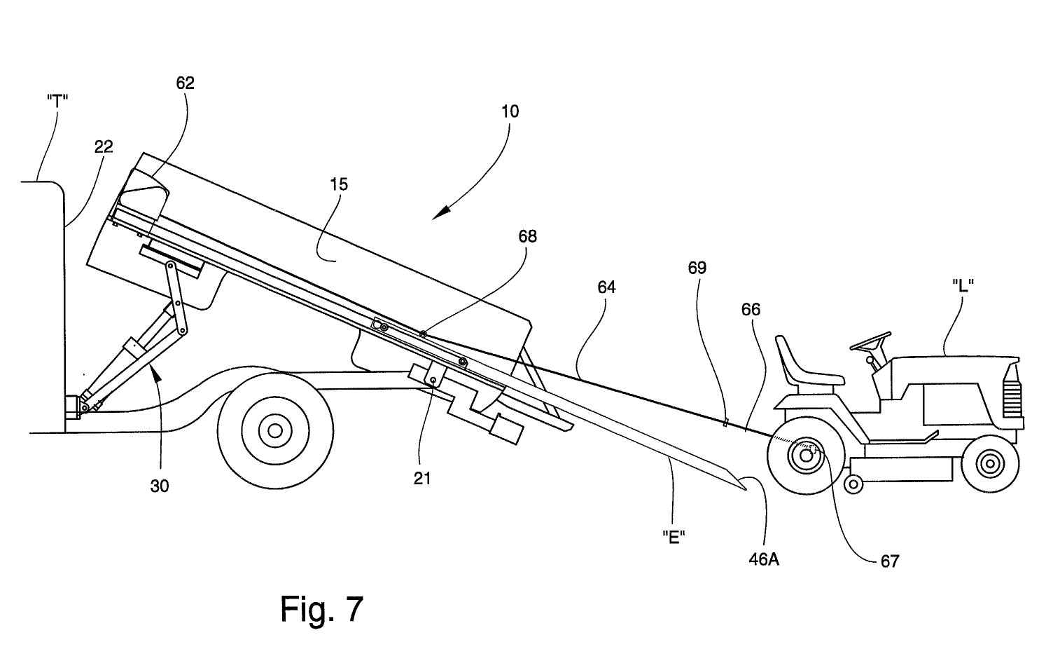

Referring again to FIG. 1, although a cargo box having any size or shape may be used, the cargo box 11 is preferably the standard, factory-installed cargo box included on the truck “T” at the time of purchase. However, unlike the factory-installed cargo box of a standard pick-up truck, which is securely affixed to the chassis of the truck, the cargo box 11 shown in FIG. 1 has been removed from the chassis 18 of the truck “T” and then re-installed thereon by mounting the rear end 13 of the cargo box 11 to the chassis 18 behind the rear wheel of the truck “T” using a hinge assembly 21. As discussed in detail below with reference to FIGS. 7 through 11, mounting the cargo box 1 1 to the chassis 18 in this manner permits the cargo box 11 to pivot relative to the chassis 18 between elevated and lowered positions.

As is shown in FIG. 1, the cargo box assembly 10 also includes an actuating lift 30 for moving the cargo box 11 between the elevated and lowered positions. Although any suitable lift may be used, the lift 30 is preferably a hydraulic lift assembled from a kit which is manufactured by Northern Hydraulics. Alternatively, any other suitable actuator capable of providing enough power to raise and lower the cargo box 11 between the elevated and lowered positions may be used. The lift 30 is connected to the floor 16 adjacent the forward end 12 and interconnects the cargo box 11 with the cab 22 of the truck “T”. The lift 30 is also connected to the electrical system of the truck “T” (not shown) for permitting the electrical system to provide power to the lift 30.

The cargo box assembly 10 also includes a ramp assembly 40 which is mounted to the floor 16. The ramp assembly 40 moves between a retracted position “R” shown in FIG. 1 and an extended position “E” shown in FIG. 3. Referring again to FIG. 2, the ramp assembly 40 includes a ramp 41 slidably mounted to a base plate 42, which is in turn mounted to the floor 16 of the cargo box 11. The base plate 42 is mounted to the floor 16 using a plurality of bolts 43, each of which extends through the base plate 42 and floor 16 and is held in place by a complementary threaded nut 44. The ramp 41 has spaced-apart, opposing side edges 41A and 41B, and, as is shown in FIG. 1, forward and back ends 45 and 46, respectively. A beveled edge 46A extends along the width of the back end 46 between side edges 41A and 41B for permitting a load to be easily moved to and from the ramp 41. The base plate 42 likewise has spaced-apart, opposing side edges 42A and 42B, and forward and back ends 42C and 42D, respectively.

As is shown in FIGS. 1 and 2, the ramp 41 is slidably connected to the base plate 42 by a carriage assembly 50. The carriage assembly 50 includes two spaced-apart guide rails 51 and 52, which are attached to the underside of the ramp 41 and extend along respective opposing side edges 41A and 41B thereof. Two spaced-apart support rails 53 and 54 are likewise attached to the underside of ramp 41 between guide rails 51 and 52, and extend along the length thereof for reinforcing and supporting the weight of the ramp. Support rails 53 and 54 slidably engage complementary support blocks 55A and 55B, respectively, which are mounted on the upper side of base plate 42 for permitting the ramp 41 to move between the retracted “R” and extended “E” positions. The ramp 41 moves between these positions using a plurality of rollers 56A and 56B which are rotatably mounted in spaced-apart relation along the length of two base rails 57 and 58, respectively. Base rails 57 and 58 are attached to and extend along the length of respective opposing side edges 42A and 42B of base plate 42. Each guide rail 51 and 52 engages and cooperates with the respective rollers 56A and 56B to allow the ramp 41 to move along the base rails 57 and 58 relative to the base plate 42. The guide rails 51 and 52, support rails 53 and 54, and base rails 57 and 58 are each preferably formed from 2″ channel steel.

Referring again to FIG. 1, the carriage assembly 50 also includes two end rollers 59A and 59B (59B is not shown), each of which are positioned on respective forward ends of guide rails 51 and 52. As is shown in FIG. 3, when the ramp assembly 40 is in the extended position “E”, end roller 59A engages the roller 56A mounted adjacent the forward end of base rail 57, thereby preventing the ramp 41 from separating from the base plate 42. When the ramp assembly 40 is in the extended position “E” shown in FIG. 3, end roller 59B likewise engages the roller 56B mounted adjacent the forward end 57A of base rail 57 for preventing the ramp 41 from separating from the base plate 42 (not shown).

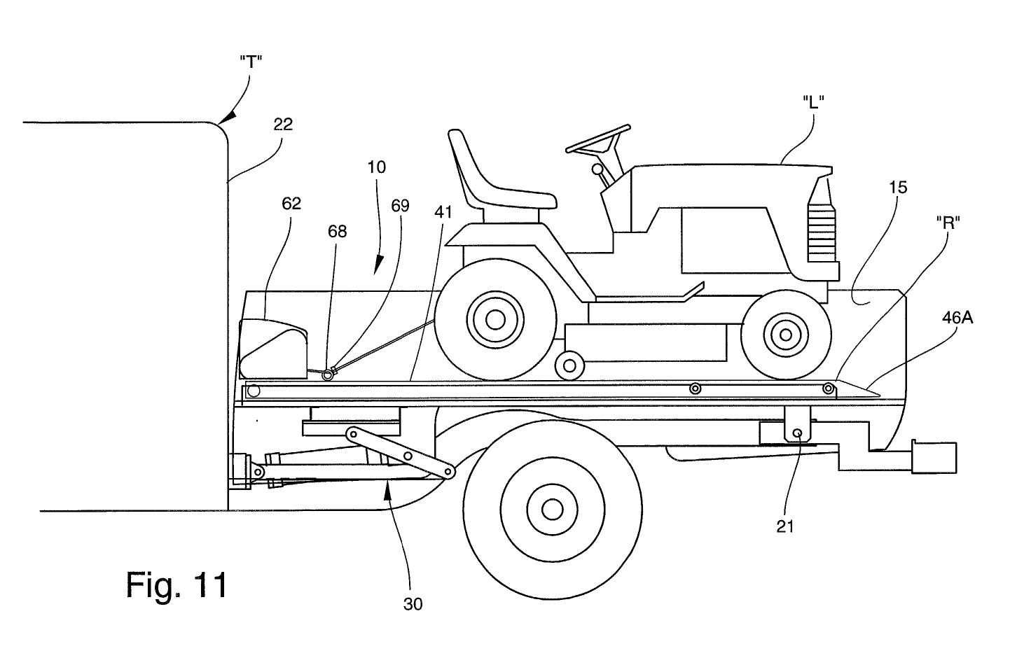

Referring again to FIG. 1, the cargo assembly 10 also includes a winding means in the form of a winch assembly 60 which is used to move the ramp 41 between the retracted position “R” shown in FIG. 1 to the extended position “E” shown in FIG. 3 for permitting a load to be moved into the cargo box 11. The winch assembly 60 includes an outer case 62 which is connected to the floor 16 adjacent the forward end 12 of the cargo box 11 by at least two bolts 63 which extend through the floor 16 and into the case 62. As is shown in FIG. 2, the winch assembly 60 also includes a retractable cable 64 coiled around a spool 65 which is rotatably mounted inside the case 62. The cable 64 has a first end 66 to which a hook 67 is attached. The hook 67 is shown in FIGS. 1 and 2 releasably connected to a complementary eye 68 which is affixed to the ramp 41. Like the ramp assembly 40, the winch assembly 60 is connected to the electrical system of the truck “T” (not shown). Movement of the ramp 41 by the winch assembly 60 is initiated by either a hand-held remote control unit or a switch mounted on the body of the truck “T” or in the interior of the cab 22 (not shown). As discussed in detail with reference to FIGS. 7 and 11 below, connecting the winch assembly 60 to the electrical system of the truck “T” provides a power source for the winch assembly 60 not only for moving the ramp 41 between the retracted and extended positions “R” and “E”, respectively, but also for transporting a load to and from the ramp 41.

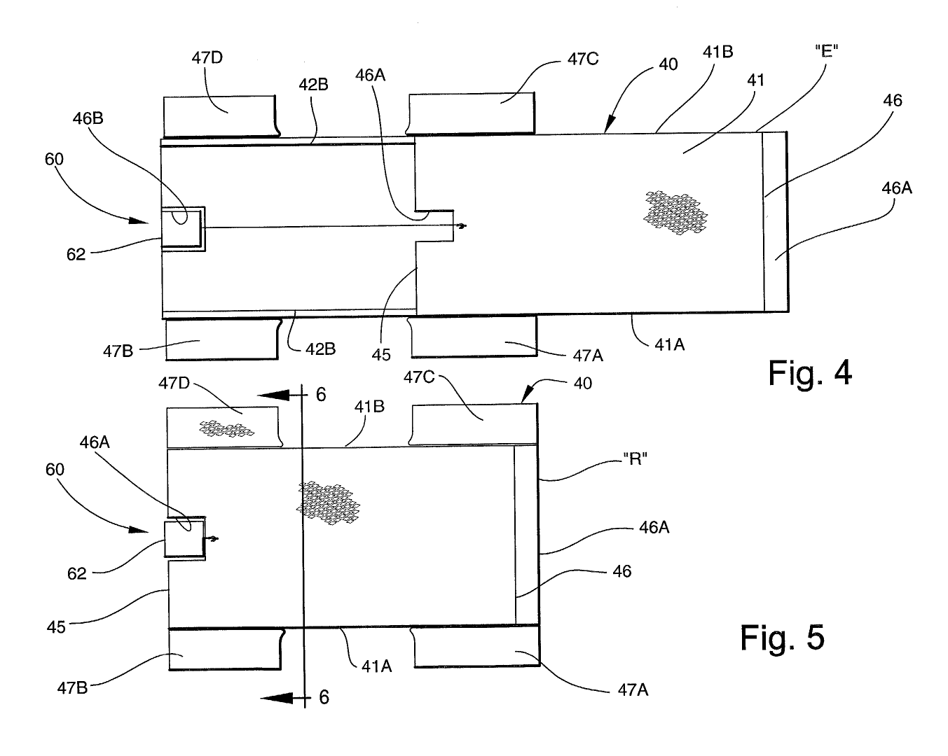

Referring now to FIGS. 4 and 5, the ramp assembly 40 and winch assembly 60 are shown removed from the cargo box 11 and truck “T” with the ramp 41 positioned in the extended and retracted positions, “E” and “R”, respectively. As is shown in FIG. 4, two holes 46A and 46B are defined by respective forward ends 45 and 42A of the ramp 41 and base plate 42. Each hole 46A and 46B has a shape complementary to that of the outer case 62 for receiving the case 62 therein when the ramp 41 is in the retracted position “R”. This permits the forward end 45 of the ramp 41 to completely cover the forward end 12 of the cargo box 11.

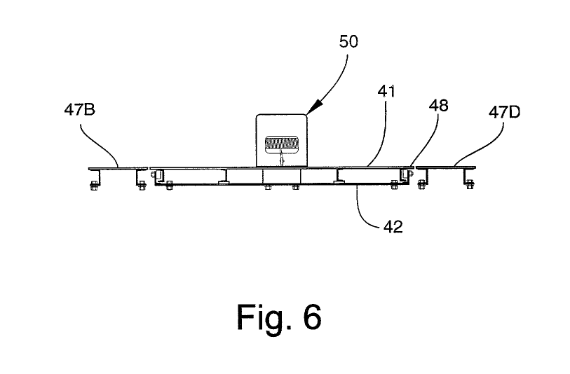

The ramp assembly 40 also includes four filler plates 47A, 47B, 47C, and 47D. Filler plates 47A and 47B are mounted to the floor 16 adjacent side edges 41A and 42B of the ramp 41 and base plate 42, respectively. Filler plates 47C and 47D are similarly mounted adjacent side edges 41B and 42B. As is shown in FIG. 6, the filler plates 47A-47D and ramp 41 create a raised floor 48. Raised floor 48 overlies the entire surface area of the floor 16 and thus prevents a load positioned on the ramp 41 from falling off the side edge 41A or 41B and becoming damaged.

Referring now to FIGS. 7 through l,the manner in which a load “L” is loaded into and positioned within the cargo box assembly 10 is shown. Although the load “L” shown in FIGS. 7 through 11 is a conventional garden tractor, the cargo box assembly 10 may alternatively be used to move any load “L” having a weight which falls within the limits of the assembly 10, including but not limited to, heavy materials placed on skids, an all-terrain vehicle, a golf cart, any other wheeled vehicle of comparable weight, or any other heavy object which cannot otherwise be easily lifted to and from the cargo box 11. FIG. 7 shows the cargo assembly 10 with the lift 30 raised so that the cargo box 11 pivots around the hinge assembly 21 into the elevated position “E”. After being used to move the ramp 41 to the extended position “E” shown in FIG. 3, the winch assembly 60 is used to begin moving the load “L” onto the ramp 41. In contrast to the cable 64, which is shown in FIGS. 1 through 3 with its hook 67 releasably connected to the eye 68, the cable 64 shown in FIG. 7 is extended through the eye 68 and the hook 67 releasably connected to the rear axle “A” of the load “L”. As is shown in FIG. 7, prior to moving the load “L” onto the ramp 41, a removable collar 69 is secured around the cable 64 adjacent the forward end 66. The collar 69 is preferably a split collar formed from complementary threaded halves which are placed around the cable 64 and then screwed together until the collar 69 is secured around the cable 64 tightly enough to be prevented from sliding along the length thereof. Once the collar 69 is secured around the cable 64, the transmission of the load “L” is preferably placed in a neutral gear to permit the wheels of the load “L” to roll in response to movement of the winch assembly 60.

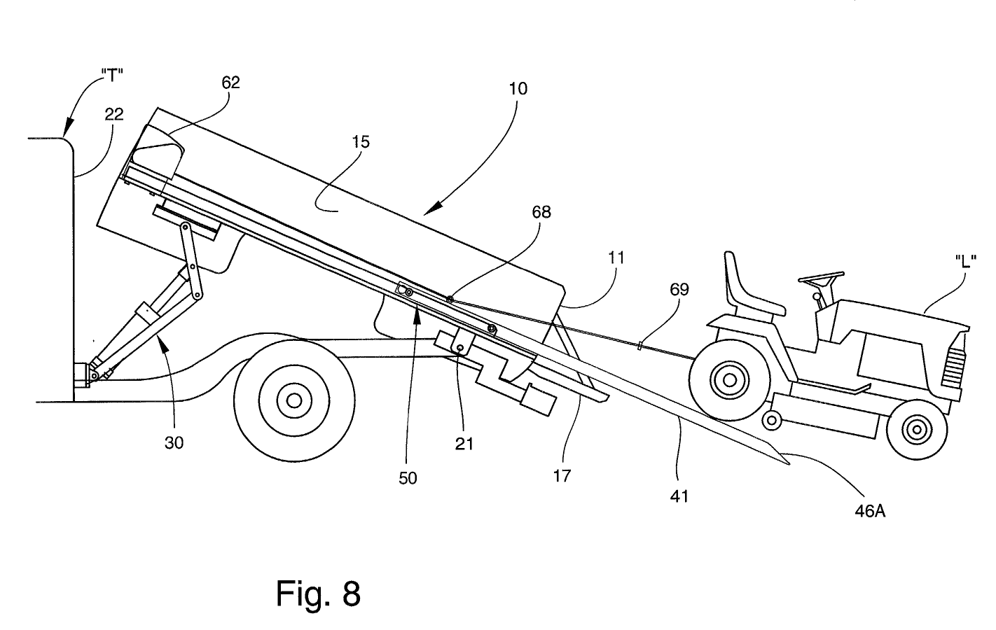

Referring now to FIG. 8, after the load “L” is secured by the hook 67 to the cable 64, the winch assembly 60 is activated, and uses power provided by the electrical supply of the vehicle (not shown) to cause the cable 64 to retract and wind around the spool 65 within the case 62 in the direction “D” shown. As the cable 64 retracts, the load “L” is pulled across the beveled edge 46A and onto the ramp 42.

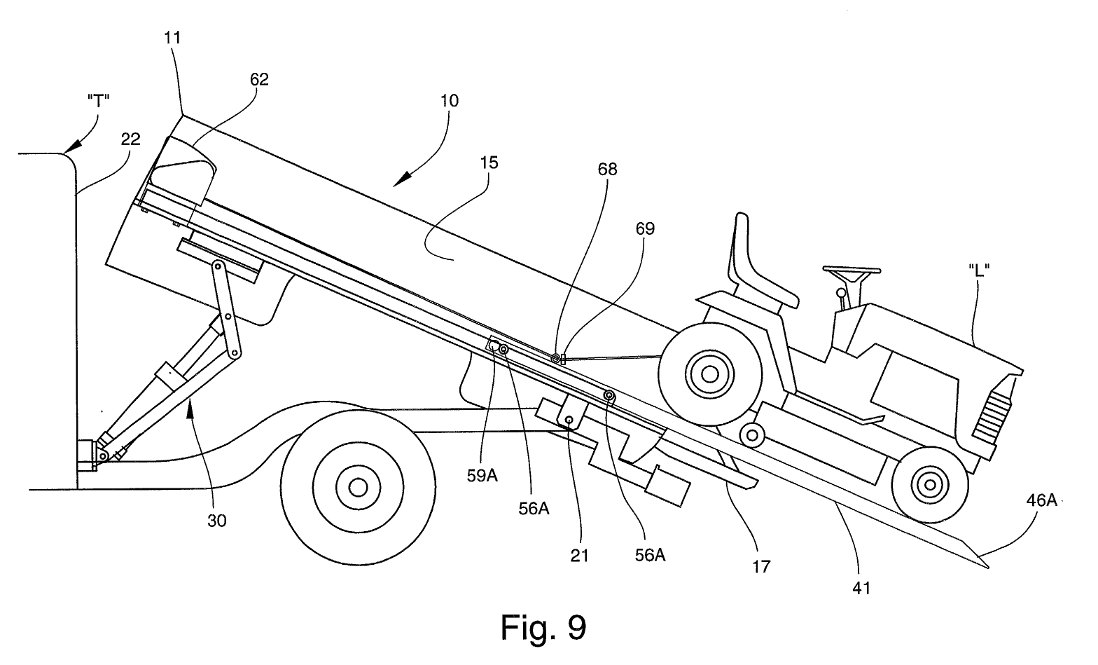

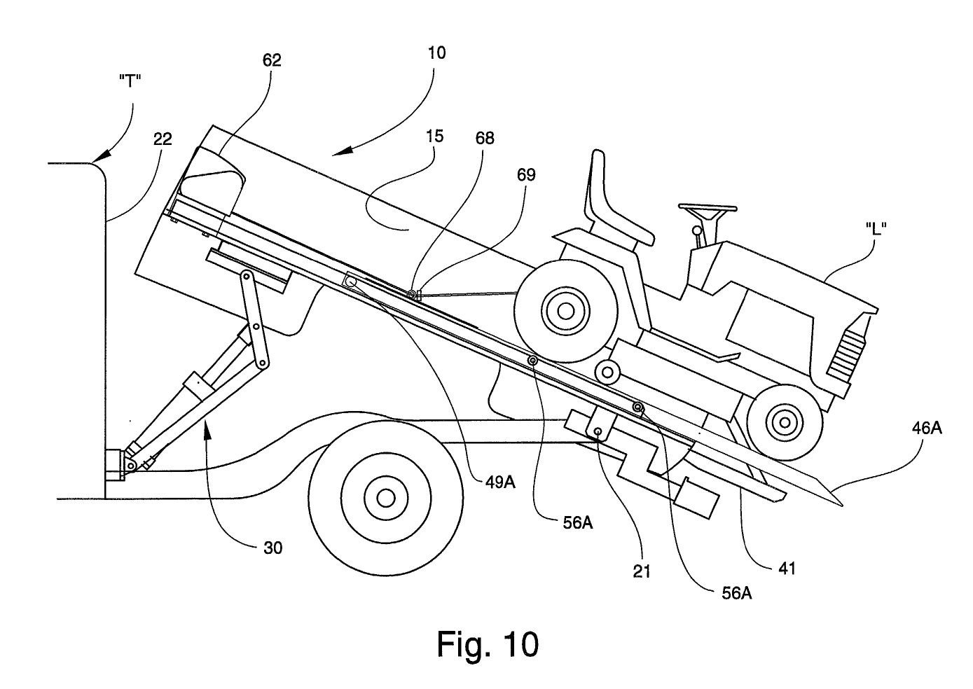

Referring now to FIG. 9, the winch assembly 60 continues retracting the cable 64 until the entire load “L” is positioned on the ramp 41 and the collar 69 encounters and engages the eye 68. As is shown in FIG. 10, once the collar 69 and eye 68 meet, the force of the collar 69 on the eye 68, which is generated by the power supplied through the winch assembly 60, causes the entire ramp 41 with the load “L” positioned thereon to begin traveling along the carriage assembly 50 from the extended position “E” until the ramp 41 is in the retracted position “R”. As is shown in FIG. 11, as soon as the ramp 41 is in the retracted position “R”, the lift 30 is activated using the electrical supply of the truck “T” and moves the cargo box 11 from the raised position to the lowered position shown, thereby completing the process of moving the load “L” into the cargo box 11. The load “L” is removed from the cargo box 11 by following the steps described above with respect to FIGS. 7 through 11 in reverse order. Specifically, the lift 30 is activated and moves the cargo box 11 from the lowered position back to the raised position. The winch assembly 60 is then activated so that the cable 64 is unwound from the spool 65, which in turn causes the ramp 41 to move from the retracted position “R” to the extended position “E”. Once the ramp 41 is fully extended, the cable 64 is further unwound so that the load “L” can be transported from the ramp 41 to the ground.

A tiltable cargo box assembly for mounting on a vehicle, supporting a load, and transporting the load into and out of the vehicle is described above. Various details of the invention may be changed without departing from its scope. Furthermore, the foregoing description of the preferred embodiment of the invention and the best mode for practicing the invention are provided for the purpose of illustration only and not for the purpose of limitation—the invention being defined by the claims.

I claim:

1. A tiltable cargo box assembly for mounting on a vehicle, supporting a load, and transporting the load into and out of the vehicle, comprising:
(a) a cargo box adapted for receiving the load therein;
(b) an attachment assembly connected to a rear end of said cargo box for pivotally mounting the cargo box to the vehicle adjacent a rear axle thereof;
(c) a ramp assembly for carrying the load and slidably mounted to a floor of the cargo box for reciprocating movement between extended and retracted positions relative to the floor of the cargo box; and
(d) an actuator mounted toward a forward end of the cargo box intermediate said attachment assembly and a forward axle of the vehicle for being operatively connected to a power source of the vehicle and cooperating with the attachment assembly for moving said forward end between:
(i) a lowered position; and
(ii) an elevated position wherein said floor of the cargo box is tilted at an angle relative to said lowered position for permitting the load to be transported into and out of the cargo box.

2. A cargo box assembly according to claim 1, wherein said ramp assembly comprises:
(a) an extendable ramp having first and second spaced-apart opposing major side edges; and
(b) a carriage assembly supporting said ramp for slidably moving the ramp relative to the floor of the cargo box, thereby moving the ramp assembly between said extended and retracted positions.

3. A cargo box assembly according to claim 2, wherein said carriage assembly comprises:
(a) first and second spaced-apart base rails carried on the floor;
(b) a plurality of rollers rotatably mounted in spaced-apart relation along the length of each of said first and second base rails; and
(c) first and second guide rails mounted to the ramp adjacent said first and second major side edges of the ramp and extending along the length thereof for engaging and cooperating with said rollers for moving the ramp relative to and along the length of the base rails.

4. A cargo box assembly according to claim 3, wherein said ramp assembly further comprises a base plate mounted to the floor of the cargo box and positioned beneath the ramp for supporting sliding movement of the ramp relative to the floor.

5. A cargo box assembly according to claim 4, wherein said cargo assembly further comprises first and second end rollers rotatably mounted on said first and second guide rails, respectively, for preventing the ramp from separating from the base plate when the ramp assembly is in the extended position.

6. A cargo box assembly according to claim 1, and including a winch assembly connected to the cargo box, operatively connected to the power source of the vehicle, and releasably connected to the ramp for moving the ramp assembly between the extended and retracted positions.

7. A cargo box assembly according to claim 6, wherein said winch assembly is connected to the floor of the cargo box adjacent the forward end thereof.

8. A cargo box assembly according to claims 6 or 7, wherein said winch assembly comprises:
(a) a cable having a first end releasably connected to the ramp; and
(b) winding means connected to a second end of said cable for winding and unwinding the cable, thereby moving the ramp assembly between the retracted and extended positions.

9. A cargo box assembly according to claim 8, wherein said winch assembly further comprises:
(a) an eye connected to the ramp for receiving said first end of the cable therethrough for permitting the first end of the cable to be releasably connected to the load and for guiding the cable as it is wound and unwound by said winding means for transporting the load into and out of the cargo box, respectively, when the forward end of the cargo box is in said elevated position;
(b) a hook attached to the first end of the cable for releasably connecting the cable to the load; and
(c) a collar encircling and engaging the cable between said eye and said hook, said collar cooperating with the eye for moving the cable through a first range of motion wherein the collar resides between the eye and the load, thereby permitting the hook to be releasably connected to the load for properly positioning the load on the ramp as the winding means rewinds the cable and through a second range of motion wherein the collar engages the eye, thereby translating movement of the cable into movement of the ramp for moving the ramp assembly between the extended and retracted positions.

10. A cargo box assembly according to claim 8, wherein said winding means comprises a winch.

11. A cargo box system for supporting and transporting a load, comprising:
(a) a truck;
(b) a cargo box pivotally mounted to said truck adjacent a rear axle thereof and adapted for receiving the load therein;
(c) an attachment assembly connected to a rear end of said cargo box for pivotally mounting the cargo box to the truck;
(d) a ramp assembly for carrying the load and slidably mounted to a floor of the cargo box for reciprocating movement between extended and retracted positions relative to the floor of the cargo box; and
(e) an actuator mounted toward a forward end of the cargo box intermediate said attachment assembly and a forward axle of the truck and operatively connected to a power source of the truck, said actuator cooperating with the attachment assembly for moving said forward end between a lowered position and an elevated position, wherein said floor of the cargo box is tilted at an angle relative to said lowered position for permitting the load to be transported into and out of the cargo box.

12. A method of supporting a load and transporting the load into and out of a vehicle, comprising:
(a) providing a tiltable cargo box assembly, comprising:
(i) a cargo box adapted for receiving the load therein;
(ii) an attachment assembly connected to a rear end of said cargo box for pivotally mounting the cargo box on the vehicle adjacent a rear axle thereof;
(iii) a ramp assembly for carrying the load and slidably mounted to a floor of the cargo box for reciprocating movement between extended and retracted positions relative to the floor of the cargo box; and
(iv) an actuator mounted towards a forward end of the cargo box intermediate said attachment assembly and a forward axle of the vehicle for being operatively connected to a power source of the vehicle and cooperating with the attachment assembly for moving said forward end between a lowered position and an elevated position, wherein said floor of the cargo box is tilted at an angle relative to said lowered position for permitting the load to be transported into and out of the cargo box;
(b) mounting said cargo box assembly on the vehicle adjacent a rear axle thereof;
(c) moving the forward end of the cargo box to said elevated position;
(d) moving said ramp assembly to said extended position;
(e) positioning the load on the ramp assembly;
(f) moving the ramp assembly to said retracted position; and
(g) moving the forward end of the cargo box to said lowered position, thereby positioning the load in the vehicle.
